(19) United States
(12) Patent Application Publication
(10) Pub. No.: US 2006/0255943 A1
(43) Pub. Date: Nov. 16, 2006

(54) Induction charging machine, methods, and system for a data reader

(75) Inventors: Robert Wayne Hougen, Eugene, OR (US); Alan Christopher Bradley, Eugene, OR (US)

Correspondence Address: STOEL RIVES LLP, 900 SW FIFTH AVENUE, SUITE 2600, PORTLAND, OR, 97204-1268, US

(73) Assignee: PSC Scanning, Inc., Eugene, OR (US)

(21) Appl. No.: 11/435,127

(22) Filed: May 16, 2006

Related U.S. Application Data
(63) Continuation-in-part of application No. 11/131,082, filed on May 16, 2005.

(51) Int. Cl. G08B 13/14

(52) U.S. Cl. 340/572.1; 340/10.1

(57) ABSTRACT

A data reading system is mountable onto a material transport device having a first section, a primary power supply and a second section movable with respect to the first section. The data reading system comprises a data reader disposed on the second section of the material transport device, the data reader comprising a power source and an induction power receiving unit. The data reading system also comprises an induction power transmission unit disposed on the first section of the material transport device and connected to the primary power supply of the material transport device. The induction power receiving unit is located proximate the induction power transmission unit when the second section is disposed in a given position with respect to the first section, whereby the induction power transmission unit transmits power to the induction power receiving unit for charging the power source of the data reader.

### RELATED APPLICATIONS

This application is a continuation in part of U.S. patent application Ser. No. 11/131,082, entitled “Apparatus and System for a Data Reader,” filed on May 16, 2005, which is hereby incorporated by reference in its entirety.

### TECHNICAL FIELD

This field of this disclosure relates generally but not exclusively to data readers such as optical code readers or RFID (radio frequency identification) readers, and more particularly, to induction charging of data readers.

### SUMMARY OF THE DISCLOSURE

According to one embodiment, a data reading system is mountable onto a material transport device having a first section, a primary power supply, and a second section movable with respect to the first section. The data reading system comprises a data reader disposed on the second section of the material transport device. The data reader comprises a power source and an induction power receiving unit. The data reading system also comprises an induction power transmission unit disposed on the first section of the material transport device and connected to the primary power supply of the material transport device. The induction power receiving unit is located proximate the induction power transmission unit when the second section is disposed in a given position with respect to the first section, whereby the induction power transmission unit transmits power to the induction power receiving unit for charging the power source of the data reader.

According to another embodiment, a method involves an apparatus mounted on a movable member of an article transport device. The article transport device comprises a main power supply, and the apparatus comprises a local power source. The method provides an induction power transmission unit electrically connected to the main power supply. The method also provides an induction receiving unit electrically connected to the local power supply of the apparatus such that, when the induction power receiving unit is in a given position proximate the induction power transmission unit, power from the induction power transmitting unit is transmitted to the induction power receiving unit by induction to thereby charge the local power source of the apparatus.

According to yet another embodiment, a material transport machine comprises a first section, a primary power supply, a second section movable with respect to the first section, an electric powered apparatus, an induction power transmission unit, and an induction power receiving unit. The electric powered apparatus is mounted on the second section and comprises a chargeable power source. The induction power transmission unit is attached to the first section and conductively connected to the primary power supply such that the primary power supply supplies power to the induction power transmission unit. The induction power receiving unit is attached to the second section and conductively connected to the power source of the electric powered apparatus. The induction power receiving unit is located proximate the induction power transmission unit when the second section is disposed in a given position with respect to the first section, whereby the induction power transmission unit transmits power to the induction power receiving unit in said given position for charging the power source of the electric powered apparatus.

Details concerning the construction and operation of particular embodiments are set forth in the following sections with reference to the below-listed drawings.

### BRIEF DESCRIPTION OF THE DRAWINGS

FIG. 1 is a drawing of a forklift with a data reader and induction charging mechanism, according to one embodiment.

FIG. 2 is a diagrammatic top view taken down the mast tower of the forklift of FIG. 1, according one embodiment.

FIG. 3 is a diagrammatic top view taken down a forklift tower having a different induction charging mechanism, according another embodiment.

FIG. 4 illustrates inductive power transfer in the embodiment shown in FIGS. 1 and 2.

FIG. 5 is a block diagram showing the functional interrelationships of the forklift and inductor coils shown in FIGS. 1, 2, or 4, according to one embodiment.

FIG. 6 is a functional block diagram of one example data reader, according to one embodiment.

FIG. 7 is a functional block diagram of an RFID interrogator and tags, according to one embodiment.

FIG. 8 is a flowchart of a method according to one embodiment.

### DETAILED DESCRIPTION OF EMBODIMENTS

With reference to the above-listed drawings, this section describes particular embodiments and their detailed construction and operation. The embodiments described herein are set forth by way of illustration only. Those skilled in the art will recognize in light of the teachings herein that variations can be made to the embodiments described herein and that other embodiments are possible. No attempt is made to exhaustively catalog all possible embodiments and all possible variations of the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

As one skilled in the art will appreciate in view of the teachings herein, certain embodiments may be capable of achieving certain advantages, including by way of example and not limitation one or more of the following: (1) elimination of bulky and troublesome cabling to/from a movable member of an article transport device; (2) resultant improved reliability of an article transport device; (3) less frequent work interruptions to replace batteries on an electric-powered apparatus on a movable member of an article transport device; and (4) greater freedom of movement of a movable member of an article transport device by untethering apparatus on the member from power cabling. These and other advantages of various embodiments will be apparent upon reading the following.

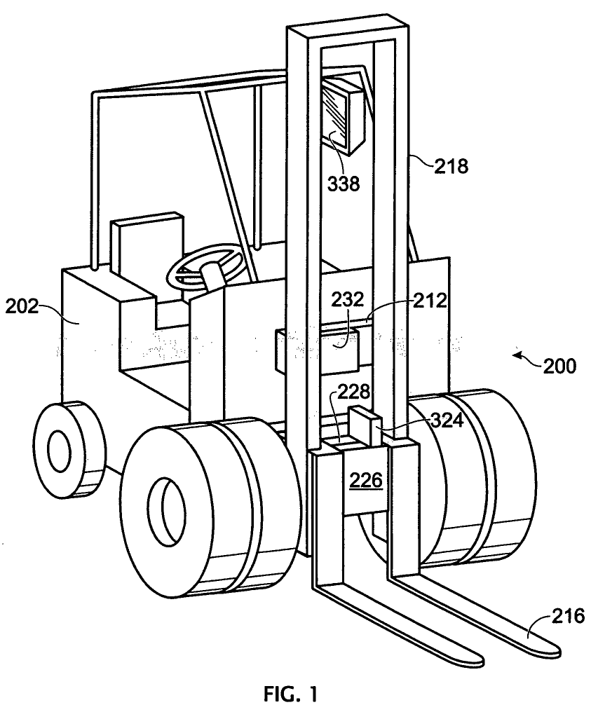

FIG. 1 depicts a forklift 200, according to one embodiment. The forklift 200 is useful to lift and transport heavy items, such as a pallet loaded with bulk (i.e., heavy or numerous or both) items. The forklift 200 comprises a cab section 202 and a mast tower 218. A movable middle element 226 moves vertically in the middle of the mast tower 218. Attached to the middle element 226 are two forks 216. Depending on the application, the lifting forks 216 may be fixedly mounted to the middle element 226 or mounted on the middle element 226 so as to allow the forks 216 to move horizontally, that is, towards or away from each other. In another embodiment, the forks 216 may also move in a tilt up or down orientation. Alternately, the mast element 212 may be mounted directly on the forklift body 202 allowing the mast tower 218 to tilt from front to back depending on the desired orientation.

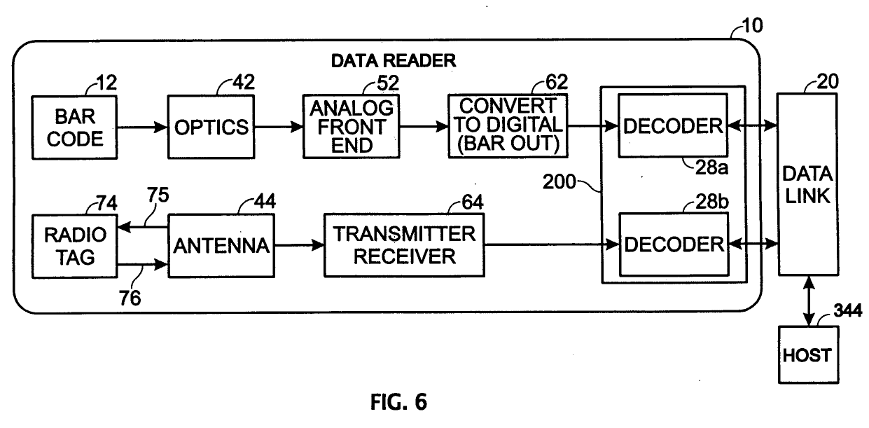

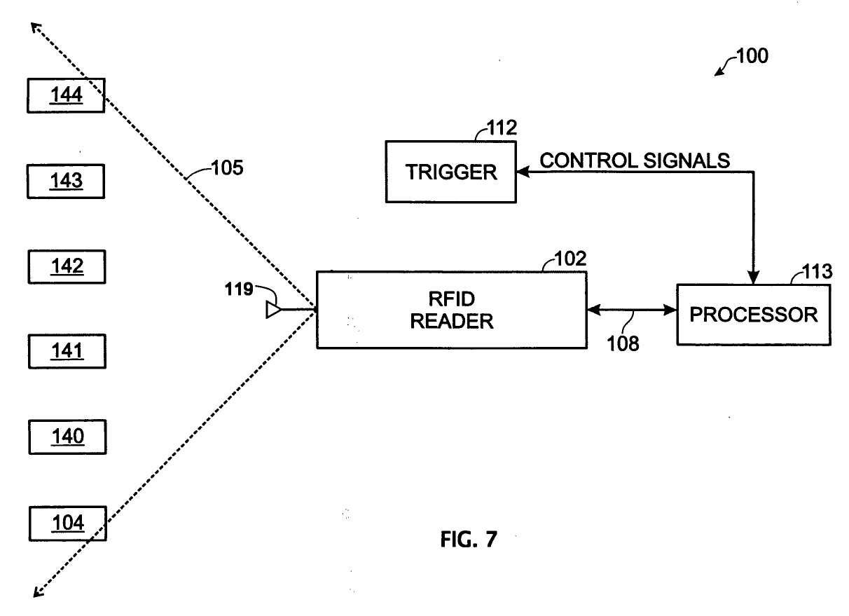

The forklift 200 is equipped with a data reader 324, which is preferably an RFID (radio frequency identification) reader (as will be described below in certain embodiments) but may be a data reader of any type, such as an optical code (e.g., bar code) reader, for example. The data reader 324 is preferably positioned on the front of the forklift 200 facing forward to enable it to read data from a pallet or its contents, container or its contents, load, or other item on the forks 216. The data reader 324 is preferably positioned above or below the middle element 226. Additional details about the data reader 324 are presented below with reference to FIGS. 6 and 7.

The data reader 324 may be electrically connected to a computer, such as a vehicle mounted computer (VMC) or other data processor (not shown) on the forklift 200 or a remote computer. Alternatively, the computer may be integrated within the data reader 324. The computer may display data on an electronic display 338 and/or may communicate the data wirelessly to another computer, such as a central computer in a warehouse, store, or other setting in which the forklift 200 operates.

In the middle of the mast tower 218 is a fixed cross member mast element 212, positioned so as to allow the middle element 226 to move vertically past the mast element 212. Attached to the mast element 212 and the middle element 226 are an induction transmission coil 232 and an induction receiver coil 228, respectively. The transmission coil 232 is fixedly attached to the mast element 212 and remains stationary relative to the forklift 200. The receiver coil 228 is fixedly attached to the middle element 226, which may be disposed into a given position. The induction coils 228 and 232 are utilized to charge or recharge the data reader 324, more specifically a power source (e.g., battery or capacitor) for or part of the data reader 324.

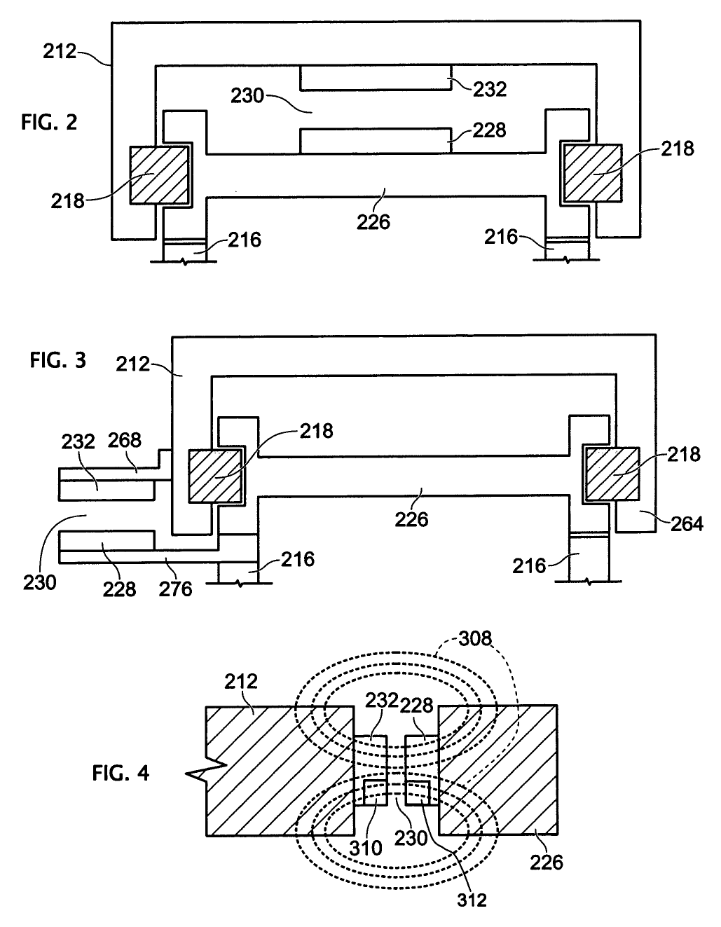

FIG. 2 is a top view taken down the mast tower 218 of the forklift 200. FIG. 2 illustrates the spatial relationship of the induction coils 228 and 232 in a horizontal plane. During charging, the receiver coil 228 is positioned within a proximate location or space 230 from the transmission coil 232. The space 230 may vary depending on the size and strength of the coils 228 and 232. As the middle element 226 slides parallel to the mast tower 218, the receiver coil 228 moves with the middle element 226. This motion allows the receiver coil 228 to be moved in and out of range with the transmission coil 232. When the coils 228 and 232 are within range of one another, the receiver coil 228 receives power that can recharge a battery or other power source for the data reader 324 or other electric-powered apparatus. Alternately, the battery is substitutable for any rechargeable device.

FIG. 3 illustrates an induction arrangement according to another embodiment. FIG. 3 is a top view taken down the mast tower 218 of the forklift 200, wherein the induction coils 228 and 232 are attached to elements 276 and 268, respectively, extending from one side of the mast tower 218, rather than in the middle of the mast tower 218. The principles of operation are otherwise the same as the induction arrangement shown in FIG. 2.

FIG. 4 graphically illustrates the inductive power transfer in the embodiment shown in FIGS. 1 and 2. FIG. 4 is a cross-section of the induction coils 228 and 232 and the elements 226 and 212 to which they are respectively attached. A sensor 310 may be mounted in an appropriate location in relation to the transmission coil 232 and an actuator 312 may be mounted in relation to the receiver coil 228. The sensor 310 and the actuator 312 interact to detect when the receiver coil 228 is within range. The sensor 310 may be one or more of a plurality of devices including, but not limited to a Hall Effect sensor, a Smith Sensor, an optical sensor and the like. The sensor 310 allows the forklift 200's main or primary power supply to power the transmission coil 232 when there is an acceptable alignment with the receiving coil 228. When the sensor 310 and actuator 312 detect the proper range, power is applied to the transmission coil 232, which forms a varying magnetic field 308. The rising and falling of the magnetic field 308 in the transmission coil 232 induces a voltage across the receiving coil 228. The induced voltage is alternating current (AC) driven and eventually converted to a constant direct current (DC) output. This induction connection allows the receiver coil 228 to charge a battery that is the power source for the data reader 324.

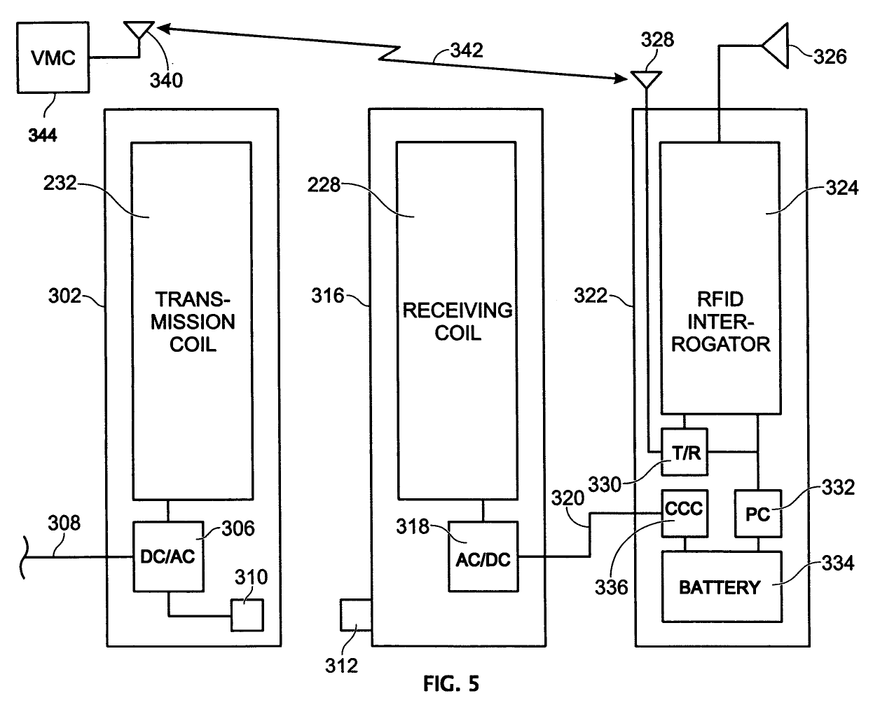

FIG. 5 is a functional block diagram of one embodiment. As shown, this embodiment comprises three housings: a first housing 302, a second housing 316 and a third or main housing 322. The sensor 310 is preferably mounted on or in the first housing 302 so that when the sensor 310 detects the actuator 312, which is preferably mounted on or in the second housing 316, the induction transmission coil 232 will begin operation. The actuator 312 may be a type that is contactless with the sensor 310. The induction transmitting coil 232 is connected to a primary or main power supply of the forklift 200 or other material handling vehicle. The induction receiving coil 228 will receive power through an induction process creating an induction power output, wherein the induction power recharges a battery 334 that powers a local power source 332 of the data reader 324, which in this case is an RFID interrogator. When the sensor 310 is not aligned with the actuator 312 or in electrical contact, no induction occurs.

The sensor 310 and the actuator 312 are optional. If not present, the transmitting coil 232 may always output power in the form of a magnetic field, and the receiving coil 228 would pick up a varying amount of power depending on its proximity to the transmitting coil 232, unless other steps are taken to selectively activate and deactivate the transmitting coil 232. The sensor-actuator pair adds the advantage of saving power when the transmitter/receiver efficiency is poor. This sensor-actuator pair may be desirable on forklifts or other material-handling devices that are battery-powered.

The first housing 302 may be mounted on the mast element 212, as shown, for example, in FIGS. 1-3. The first housing contains a transmission coil 232, a DC-to-AC converter 306, a primary power supply cable 308 and the sensor 310. The primary power supply cable 308 typically supplies primary power in the form of DC voltage from a primary power supply or source (e.g., battery or generator (not shown)) that may be mounted on the forklift 200 or other material handling device. In addition, the primary power supply provides the electrical power needed to operate the forklift 200 or other material handling device. When the sensor 310 detects the actuator 312, DC power is converted to AC power in the DC-to-AC converter 306, wherein AC power is supplied to the transmission coil 232. The transmission coil 232 may be a constructed out of wire, such as copper wire, that is wound around a core. The diameter of the copper wire and the number of times the copper wire is wound around the core is dependent on the voltage desired.

Furthermore, the copper wire is substitutable for any conductive material that is capable of providing a rising and falling magnetic field in a transmission coil when supplied with AC current.

The rising and falling of a magnetic field in the transmission coil 232 induces a voltage across the receiving coil 228. An AC-to-DC converter 318 then converts the AC voltages across the receiving coil 228 to a relatively constant DC voltage. The DC power is transmitted to the battery 334 through a recharge power cable 320 and a charge control circuit 336. The receiving coil 228 is mounted in the second housing 316. The second housing 316 is fixedly mounted on the middle element 226, as shown, in FIGS. 1-3. The second housing 316 includes the receiving coil 228, the AC-to-DC converter 318, and one end of the recharge power cable 320.

The third or main housing 322 includes the data reader, which as shown in FIG. 5 for the sake of illustration is a RFID interrogator 324, one or more RFID transmitting/receiving (T/R) antennae 326, a communication transmitter/receiver 330, a T/R antenna 328, a power conditioner 332, the battery 334 and a charge control circuit 336. Recharge power from the receiver coil 228 is transmitted to the charge control circuit 336 via the AC-to-DC converter 318 and the recharge power cable 320. The charge control circuit 336 determines whether the rechargeable battery 334 needs to be charged with DC output power from the AC-to-DC converter 318. The battery 334 provides DC power to the power conditioner 332, which in turn provides filtered power to the communication transmitter/receiver 330 and the data reader 324. Typically, the main housing 322 is mounted on top of the middle element 226 (FIGS. 1-3) and the RFID antenna 326 may have a “look-down” or “look-out” coverage of RFID tags that the forklift 200 has moved into a read position or as necessary to properly read the tags. The recharge power cable 320 is fixedly mounted on the middle element 212 (FIGS. 1-3) connecting the second housing 316 to the main housing 322. Alternately, the second and main housings may be combined into a single housing eliminating the recharge power cable 320.

The data reader 324 in the third housing 322 communicates, that is transmits and receives signals, with a vehicle-mounted computer (VMC) 344 or other host computer, controller, or processor via a second wireless link 342. A particular tag (not shown) is read by the RFID interrogator 324 through a first transmitter/receiver (T/R) antenna 326. The interrogator 324 communicates with the communication transmitter/receiver 330 which can transmit a signal through a second T/R antenna 328 to the VMC 344. The transmitted signal is received by the VMC 344 through a third T/R antenna 340. The VMC 344 may act as a host computer to identify the desired RFID tag or to process decoded RFID tag information.

Another example of the data reader 324 is shown in FIG. 6, which illustrates a functional block diagram of a multiple-technology data reader 10, which can read an optical code 12 or an RFID transponder or tag 74. The data reader 10 can be used with the movable vehicle induction technique described herein. For example, an optical code 12 is read or imaged by an optics module 42, which sends the detected signal to an analog front end 52. The analog signal is then converted to a digital signal by an analog-to-digital converter 62. The converted signal is decoded by a bar code decoder 28a and then sent to the VMC 344 via a data link 342, which may be wireless. Moreover, a signal from the RFID transponder or tag 74 is detected by an antenna 44. The antenna radiates an electromagnetic signal 75 and detects a response signal 76 from the RFID tag 74. The response signal 76 is sent to an RFID transmitter/receiver 64. The response signal 76 is then decoded by an RFID decoder 28b and then sent to the host computer 30 via the data link 20. One such multiple-technology reader is described in U.S. Pat. No. 6,415,978, issued to McAllister, entitled “Multiple Technology Data Reader For Bar Code Labels And RFID Tags,” the entire contents of said patent are incorporated herein by reference and made part of this disclosure.

Another example of the data reader 324 is the RFID apparatus 100 illustrated in FIG. 7. An RFID system typically employs at least two components: a “transponder” or “tag,” which is attached to the physical item to be identified, and an “interrogator” or “reader,” which sends an electromagnetic signal to the transponder and then detects a response. A typical tag stores useful information such as an identification code for the item to which it is attached. A typical reader emits an RF (radio frequency) signal that is received by the tag after the tag comes within an appropriate range. In response to the signal from the reader, the tag sends back to the reader a modulated RF signal containing the tag's information. The reader detects this modulated signal and can identify the tag by demodulating and decoding the received signal. After identifying the tag, the reader can either store the decoded information or transmit the decoded signal to a computer. The tag used in an RFID system may be either “passive” or “active.” A passive tag can be a simple resonant circuit, including an inductive coil and a capacitor. Passive tags are generally powered by the carrier signal transmitted from the reader. Active tags, on the other hand, generally include transistors or other active circuitry, and require their own battery source. Moreover, a tag's memory may be writable, and an RFID reader may transmit data to an RFID tag to overwrite the tag's memory.

In the RFID system illustrated in FIG. 7, an RFID reader or interrogator 102 is used to identify one or more particular RFID tag(s) in a plurality of RFID tags, including but not limited to, tags 104, 140, 141, 142, 143 and 144. The RFID apparatus 100 may be fixedly mounted or removably mounted on the forklift 200 or other material handling vehicle or device. When such a device moves toward the RFID tags, the RFID interrogator 102 interrogates the RFID tags. An electromagnetic signal 105 is transmitted through an antenna 119 and received by the tags when in range. An operator would typically drive the forklift 200 to the vicinity of the tags, wherein the fixedly located interrogator 102 interrogates the tags. Alternately, the RFID apparatus 100 is may be a removable hand-held unit that is useable by the operator of the forklift 200 or a material handling vehicle.

The interrogator 102 may be connected via a first wireless link 108 or other suitable interface to a processor 113. An activation switch, such as a trigger 112, may provide control signals to the processor 113. The trigger 112 may be activated by a touch screen on the electronic display 338 or the control logic 109 may trigger a reading. Operator feedback may be provided by auditory or visual means or both, for example.

While certain embodiments described above refer specifically to an RFID interrogator mounted on a forklift, a practitioner in the art will recognize the principles described herein are viable with other devices and in other applications. For example, the forklift 200 may be any material-handling machine such as walk-behind material lifts, material transfer carts, automated material movers and the like. In general, the inductive charging techniques described herein can be utilized to wirelessly provide power to any electric-powered apparatus on a movable element of a material-handling machine and to thereby avoid the disadvantages attendant with power cabling to/from a movable element.

Data readers or other electric-powered apparatus that are used on forklifts or other material handing devices pose a number of problems for reliable operation. For example, one arrangement requires a long cable, which lowers the reliability of the system because the cable is prone to damage by the frequent movement of the cable as the device operates (e.g., as the forks 216 move up and down). Damaged cabling can pose a safety risk. Replacement of damaged cabling, in addition to being costly, can interrupt the workflow of the operator and lead to down time. While the need for power cabling can be eliminated by utilizing a battery to power the data reader or other electric-powered apparatus, batteries need to be changed, replaced, charged, or recharged from time to time. Such battery recharging or replacements represent an added cost and can also interrupt the workflow of the operator and lead to down time. The inductive charging techniques described herein are wireless in the segment where relative motion occurs and can therefore avoid these disadvantages. Moreover, when the data link from the data reader or other electric-powered apparatus is wireless, then the apparatus can be truly wireless, completely untethered by power or data cables. This untethered approach can permit design of material handling machines with greater range and type of movement.

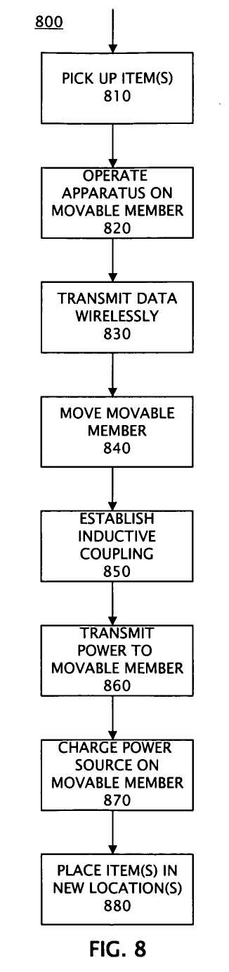

FIG. 8 is a flowchart of a method 800 according to one embodiment. The method 800 begins by picking up items (step 810) using a material or article transport or handling machine or device (hereafter “article transport device”). The article transport device has a movable member that moves with respect to the rest of the article transport devices, such as by a lifting or conveying operation. On that movable member is an electric-powered apparatus, such as a data reader, scale, imager, data collection apparatus, etc. The method 800 operates (step 820) the apparatus, typically acting on the item(s) or its container. The method 800 may optionally wirelessly transmit (step 830) data related to or derived from the operation of the apparatus to another location, such as computer, which may be located on the article transport device away from the movable member or elsewhere. The method 800 also moves (step 840) the movable member, typically as part of the article transport operation. When the movable member is in a given position, which may be a nominal rest or loading position, the method 800 establishes (step 850) an inductive coupling between inductive elements on the movable member and a fixed member on the article transport device. Thereafter, the method 800 transmits (step 860) power from the fixed member to the movable member via induction. This in turn enables the method 800 to charge (step 870) a power source associated with the electric-powered apparatus on the movable member. At some point, the method 800 places (step 880) the item(s) in new location(s). In the course of moving the movable member back into a pick-up position thereafter, then the steps 860-870 may be performed again. In general, the method 800 is performed repeatedly.

The steps of the method 800 may be performed in an order different from what is illustrated, steps may be performed simultaneously, and other steps not illustrated may also be performed. For example, charging may occur when the machine is idle or not transporting articles, such as when the forks 216 of the forklift 200 are in a rest position (e.g., a lowered position). As another example, reading of data may occur as the device passes by, becomes proximate to, or is directed at the articles; in other words, it may not be necessary that the articles be on the forks 216, for example, to be read.

The terms and descriptions used herein are set forth by way of illustration only and are not meant as limitations. Similarly, the embodiments described herein are set forth by way of illustration only and are not the only means of practicing the invention. Those skilled in the art will recognize that many variations can be made to the details of the above-described embodiments without departing from the underlying principles of the invention. The scope of the invention should therefore be determined only by the following claims (and their equivalents) in which all terms are to be understood in their broadest reasonable sense unless otherwise indicated.

1. A data reading system mountable onto a material transport device having a first section, a primary power supply mounted on the first section, and a second section movable with respect to the first section, the data reading system comprising:
a data reader disposed on the second section of the material transport device, the data reader comprising a power source and an induction power receiving unit; and
an induction power transmission unit disposed on the first section of the material transport device and connected to the primary power supply of the material transport device;
wherein the induction power receiving unit is located proximate the induction power transmission unit when the second section is disposed in a given position with respect to the first section, whereby the induction power transmission unit transmits power to the induction power receiving unit for charging the power source of the data reader.

2. A system as set forth in claim 1, wherein the material transport device is selected from the group consisting of a forklift, a material lift, a material transfer cart, and a material mover.

3. A system as set forth in claim 1, wherein the material transport device is a vehicle.

4. A system as set forth in claim 1, wherein the first section of the material transport device is a mast and the second section of the material transport device moves along the mast.

5. A system as set forth in claim 1, wherein the power source comprises a rechargeable device.

6. A system as set forth in claim 1, wherein the data reader further comprises an RFID interrogator.

7. A system as set forth in claim 1, wherein the data reader further comprises an optical code reader.

8. A method for use with an apparatus mounted on a movable member of an article transport device, wherein the article transport device comprises a main power supply and the apparatus comprises a local power source, the method comprising:
providing an induction power transmission unit electrically connected to the main power supply; and
providing an induction receiving unit electrically connected to the local power supply of the apparatus such that, when the induction power receiving unit is in a given position proximate the induction power transmission unit, power from the induction power transmitting unit is transmitted to the induction power receiving unit by induction to thereby charge the local power source of the apparatus.

9. A method as set forth in claim 8, further comprising:
providing the apparatus and mounting the apparatus on the movable member of the article transport device.

10. A method as set forth in claim 9, wherein the apparatus is a data reader.

11. A method as set forth in claim 10, wherein the data reader comprises an RFID interrogator.

12. A method as set forth in claim 10, wherein the data reader comprises an optical code reader.

13. A method as set forth in claim 8, further comprising:
providing a wireless communications link between the apparatus and a host.

14. A method as set forth in claim 13, wherein the host is a computer mounted on the article transport device.

15. A method as set forth in claim 8, wherein the article transport device is a vehicle.

16. A method as set forth in claim 15, wherein the vehicle is a forklift having forks to lift articles, and the movable member moves in unison with the forks.

17. A method as set forth in claim 8, wherein the local power source comprises a rechargeable battery.

18. A method as set forth in claim 8, further comprising:
moving the movable member such that the induction power receiving unit is in a given position proximate the induction power transmission unit;
transmitting power from the induction power transmitting unit to the induction power receiving unit by induction when the induction power receiving unit is in the given position; and
charging the local power source of the apparatus using the power transmitted by induction.

19. A material transport machine comprising:
a first section,
a primary power supply mounted on the first section, and
a second section movable with respect to the first section;
an electric powered apparatus mounted on the second section, the electric powered apparatus comprising a chargeable power source;
an induction power transmission unit attached to the first section and conductively connected to the primary power supply such that the primary power supply supplies power to the induction power transmission unit; and
an induction power receiving unit attached to the second section and conductively connected to the power source of the electric powered apparatus, wherein the induction power receiving unit is located proximate the induction power transmission unit when the second section is disposed in a given position with respect to the first section, whereby the induction power transmission unit transmits power to the induction power receiving unit in said given position for charging the power source of the electric powered apparatus.

20. A machine as set forth in claim 19, wherein the machine is selected from the group consisting of a forklift, a material lift, a material transfer cart, and a material mover.

21. A machine as set forth in claim 19, wherein the material transport machine is a vehicle.

22. A machine as set forth in claim 19, wherein the first section of the material transport machine comprises a mast and the second section of the material transport device moves along the mast.

23. A machine as set forth in claim 19, wherein the power source comprises a rechargeable battery.

24. A machine as set forth in claim 19, wherein the apparatus is a data reader.

25. A machine as set forth in claim 24, wherein the data reader comprises an RFID interrogator.

26. A machine as set forth in claim 24, wherein the data reader comprises an optical code reader.

27. A machine as set forth in claim 19, further comprising:
a computer; and
a wireless communication link between the computer and the electric powered apparatus.

28. A machine as set forth in claim 19, wherein the first and second sections of the material transport machine are physically connected during normal operation.

29. A machine as set forth in claim 19, wherein the material transport device is designed to move bulk items.
